(19) United States
(12) Patent Application Publication
(10) Pub. No.: US 2003/0101088 A1
(43) Pub. Date: May 29, 2003

(54) Web-based survey method for measuring customer service response

(76) Inventor: Suriyan Lohavichan, Arlington, MA (US)

Correspondence Address: MIRICK O'CONNELL, 1700 WEST PARK DRIVE, WESTBOROUGH, MA, 01581-3941, US

(21) Appl. No.: 09/994,581

(22) Filed: Nov. 27, 2001

Related U.S. Application Data
(60) Provisional application No. 60/253,289, filed on Nov. 27, 2000.

(51) Int. Cl. G06F 17/60

(52) U.S. Cl. 705/10

(57) ABSTRACT

A web-based survey method for measuring customer service response, comprising: creating and storing a plurality of questions to be sent to customer service web sites; grouping the questions into one or more groups; storing service web site destination identifying information; defining the parameters of a service survey, including at least the questions for the survey and the service web site destination identifying information; responsive to at least one parameter of the defined survey, automatically transmitting one or more questions from the survey to one or more service web site destinations from the survey; storing emailed responses received from the destination service web sites; and automatically extracting and storing data from the stored emailed responses.

### CROSS-REFERENCE TO RELATED APPLICATION

This application claims benefit of Provisional application serial No. 60/253,289, filed on Nov. 27, 2000.

### FIELD OF THE INVENTION

This invention relates to a method of measuring web-based customer service response.

### BACKGROUND OF THE INVENTION

Marketing, sales and customer support managers at Fortune 1000 firms and dot corns need to be able to determine the effectiveness of internet-based customer service operations as compared to their competitors, and to keep track of their competitors' service performance. Also, analysts and consultants with internet research and internet strategy firms need to collect data on the industry so it can be used for analysis, for example to draw conclusions or to validate certain forecasts.

Such information can be gathered by sending customer service inquiries, and measuring the responses. However, these tasks are very labor intensive, thus using valuable human resources the savings of which are, by definition, the primary purpose of a company's internet-based customer service operation to begin with. Accordingly, there is a disincentive for companies to accurately measure their own customer service performance, which itself can lead to poor service.

### SUMMARY OF THE INVENTION

This invention provides internet customer service metrics to corporations and others, with minimal use of human resources. This allows companies to easily review and benchmark their internet customer service capabilities. The inventive methodology will allow a company to benchmark their customer service levels via e-mail. Companies can then compare their performance to their competitors, and to industry averages. The benchmarking will focus on measuring four main areas: speed of the service, personalization of the service, format of the service, and accuracy of the service. Within each area there are a number of factors that can be analyzed.

The primary target audience is marketing, sales and customer support managers at Fortune 1000 firms and dot corns that need to be able to determine how their company is doing versus others, and to keep track of competitors' service operations. The secondary target audience is analysts and consultants with internet research and internet strategy firms that need to collect data on the industry so it can be used for analysis, to draw conclusions or to validate certain forecasts.

The following are functions that are required in the preferred embodiment of the invention:

User Definable Functions:

Define Survey Parameters

Allow users to create questions and group them

Allow users to create e-mail addresses and group them

Allow users to create categories for e-mail addresses and questions

Allow users to create “dummy” users and group them

Have a mechanism for generating analysis, charts and reports on the collected data

Store information about the user

Structural Functions:

A mechanism for securely logging into the system

A mechanism for generating, selecting and removing e-mail addresses

A mechanism for receiving e-mail

A mechanism for sending e-mail

A mechanism for submitting data to web based forms

This invention features a web-based survey method for measuring customer service response, comprising: creating and storing a plurality of questions to be sent to customer service web sites; grouping the questions into one or more groups; storing service web site destination identifying information; defining the parameters of a service survey, including at least the questions for the survey and the service web site destination identifying information; responsive to at least one parameter of the defined survey, automatically transmitting one or more questions from the survey to one or more service web site destinations from the survey; storing emailed responses received from the destination service web sites; and automatically extracting and storing data from the stored emailed responses.

There may be a plurality of groups of questions. The service web site destination identifying information may comprise email addresses. The service web site destination identifying information may also comprise the address of a web-based form.

Defining service survey parameters may further include defining the survey start time, the survey end time, and the survey frequency between the start time and end time. Defining service survey parameters may still further include selecting a question group.

The web-based survey method may further comprise creating and storing one or more dummy user profiles. In this case, defining service survey parameters may further include selecting at least one dummy user profile for the survey.

The web-based survey method may further comprise storing user actions involved in completing a web-based form. In this case, automatically transmitting questions may further comprise using the stored user actions to place appropriate information (including but not limited to the questions) in different fields of a web-based form. Automatically extracting data may include resolving information from both the header and body of the emailed responses received.

Featured in a more specific embodiment is a web-based survey method for measuring customer service response, comprising: creating and storing a plurality of questions to be sent to customer service web sites; grouping the questions into a plurality of groups; creating and storing one or more dummy user profiles; storing service web site destination identifying information, including at least email addresses; defining the parameters of a service survey, including at least selecting a question group for the survey, selecting the service web site destination email addresses, and selecting at least one dummy user profile for the survey; responsive to at least one parameter of the defined survey, automatically transmitting one or more questions from the survey to one or more service web site destinations from the survey; storing emailed responses received from the destination service web sites; and automatically extracting and storing data from the stored emailed responses.

Featured in yet another more specific embodiment is a web-based survey method for measuring customer service response, comprising: creating and storing a plurality of questions to be sent to customer service web sites; grouping the questions into a plurality of groups of questions; storing service web site destination identifying information, wherein the service web site destination identifying information comprises at least the address of a web-based form; storing user actions involved in completing a web-based form; defining the parameters of a service survey, including at least the questions for the survey and the service web site destination identifying information; responsive to at least one parameter of the defined survey, automatically using the stored user actions to place appropriate information in different fields of a web-based form, including transmitting one or more questions from the survey; storing emailed responses received from the destination service web sites; and automatically extracting and storing data from the stored emailed responses.

### BRIEF DESCRIPTION OF THE DRAWINGS

Other objects, features and advantages will occur to those skilled in the art from the following description of the preferred embodiment of the invention, and the accompanying drawings, in which:

FIG. 1 is a high-level flow chart of the preferred methodology of the invention; and

FIG. 2 is a more detailed hardware and software flow chart of the preferred embodiment of the invention.

### DETAILED DESCRIPTION OF THE PREFERRED EMBODIMENT OF THE INVENTION

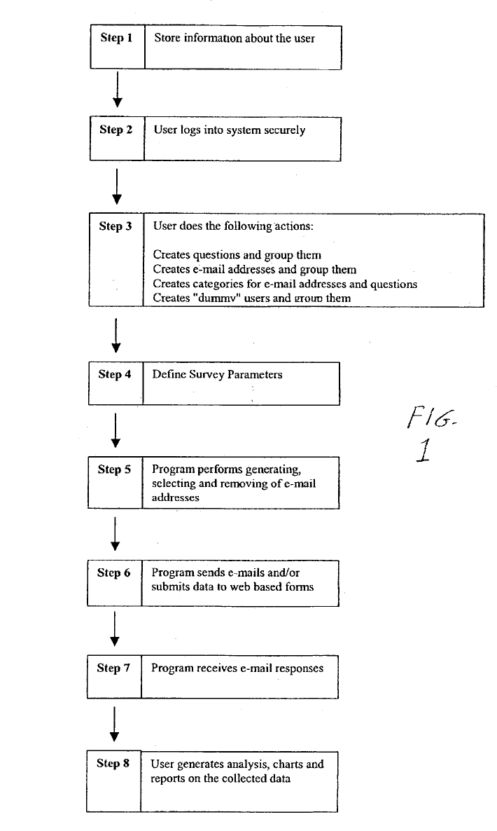

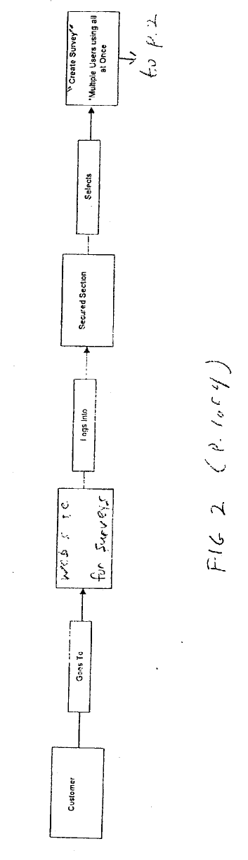

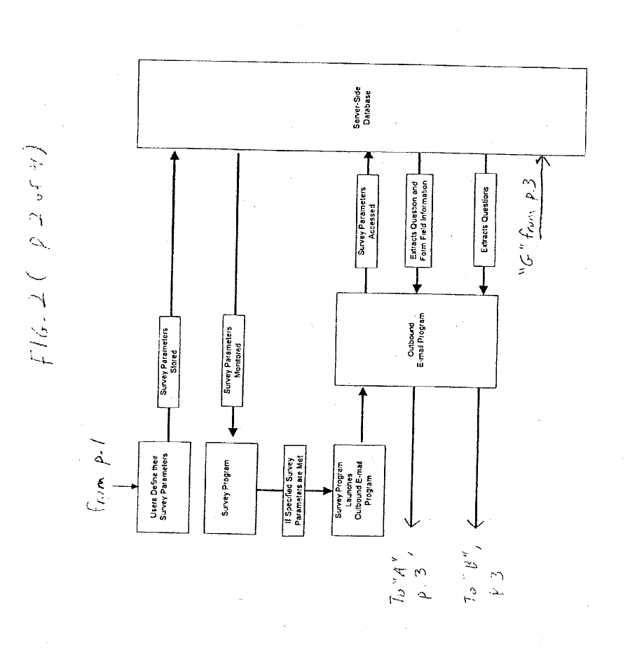

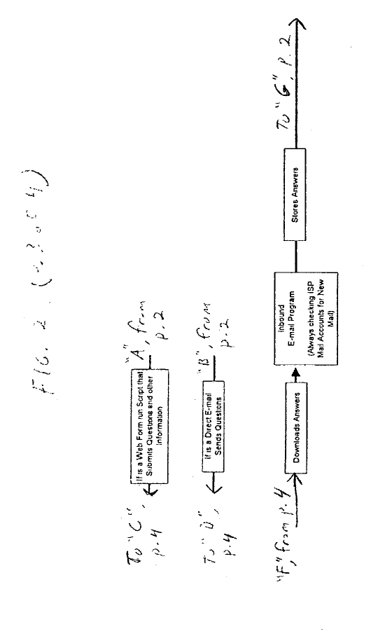

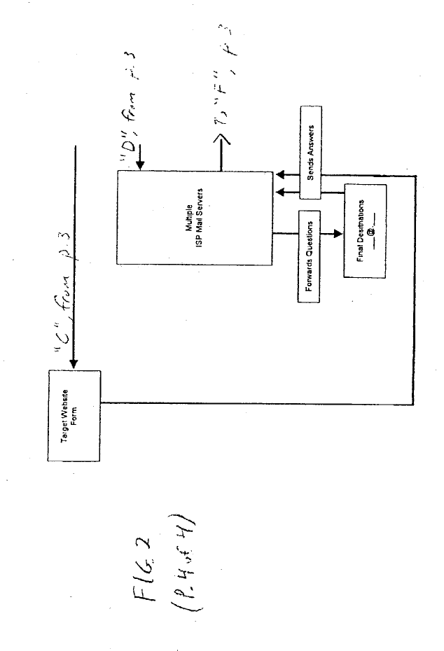

The following are the functions and a description of the different aspects of the preferred embodiment of the invention. The method of the invention can be accomplished with a computer program running on standard hardware. Particular hardware requirements are based primarily on the sizes of the surveys being conducted and the frequency at which the surveys are conducted. The reference numbers are to the different portions of FIGS. 1 and 2.

Store Information About the User (Step 1)

Purpose:

To store the real information about the user using the system, including contact information, user id, password, billing information, and any user setup preferences and parameters. Most of this information is entered by the user. However, it also includes maximum allowances for survey parameters and database sizes. These are system parameters set by the administrator only and regulate how much the user can do based off of which plan they decide to purchase. These should not be accessible by the user.

User Actions Available:

Allow the user to enter their name, address, phone, e-mail information, etc . . .

Allow the user to setup their system preferences

Allow the user to edit and save their information

Logging Into System Securely (Step 2)

Purpose:

The program employs user Id's and passwords so that only authorized users are allowed access to the system. It preferably also tracks the user's actions for analysis about what is going on in the system as it is being used.

Create Questions and Group Them (Step 3)

Purpose:

Lets the user create questions for the survey(s), with subjects. This lets the user store all the individual questions so that later they can be accessed by the program and sent to various e-mail addresses. The user should also have the ability to group the created questions into groups to be selected for use in the survey parameters setup, as well as classify the questions into categories.

User Actions Available:

Allow the user to name the question

Allow the user to enter subject text

Allow the user to enter question text

Allow the user to classify the question into a category

Allow the user to write a note

Allow the user to name the question group list

Allow the user to add or delete questions into the group list

Allow the user to write a note about this group list

Allow the user to add, delete or edit the question group list

Create E-Mail Addresses and Group Them (Step 3)

Purpose:

The user needs to have the ability to enter e-mail addresses into the system so that they can be used by the program as destinations for the emailed survey question(s). Additionally, the user needs to be able to group the addresses together into common lists so that later the user can select a specific list for the survey to perform on, instead of having to enter each address one by one.

User Actions Available:

Allow the user to name the address

Allow the user to enter the e-mail address

Allow the user to classify it into a category

Allow the user to enter the homepage where the address can be found

Allow the user to write a note about this e-mail address

Allow the user to add, delete or edit the address

Allow the user to name the e-mail group list

Allow the user to add or delete e-mail and form addresses into the group list

Allow the user to write a note about this group list

Allow the user to add, delete or edit the e-mail group list

Explanation:

All information should be saved and retrievable later by the user so that it can be modified or deleted. Additionally, the user should have the ability to access a common file area where addresses are stored, so the user doesn't have to retype or lookup addresses. The program also needs the ability to verify that the addresses have not changed and are still the ones listed on the destination website. A verification program could be built that monitors the website address for a change in the address and gives the user the option of determining how to handle different scenarios, for example a change in website URL

Create Categories for E-Mail Addresses and Questions (Step 3)

Purpose:

Stores categorization schemes for e-mail addresses and forms where e-mails are submitted. This allows the user to group different sets of e-mail addresses together for easier retrieval. For example, to send the survey to all addresses categorized as “autos”. Additionally, allows for data analysis by categorization scheme.

User Actions Available:

Allow the user to name the category

Allow the user to write a note about this category

Allow the user to add, delete or edit categories

Explanation:

The user should have the ability to select a shared database to select and import pre-made categories if they do not wish to create their own.

Create “Dummy” Users and Group Them (Step 3)

Purpose:

Lets the user create fictitious identities representing who is sending the e-mail questions. This will be used mainly for submitting forms based data. This gives the user a database to connect the form fields to for entry as the automated process submits data. Many forms will not allow the submission of a question/comment without the entry of some type of validly accepted data identifying the user, for example a return email, or name and address. This table allows the survey to automatically accomplish that. Some of these data fields may contain “N/A” or other improvised values designating that the user does not want to disclose personal information. This should be acceptable to the program and submittable to the form.

User Actions Available:

Allow the user to name the profile

Allow the user to enter name, address, phone, e-mail information, etc . . .

Allow the user to create user definable information categories

Allow the user to add, delete or edit the profile

Allow the user to write a note about the profile

Allow the user to name the profile group list

Allow the user to add or delete profiles into the group list

Allow the user to write a note about this group list

Allow the user to add, delete or edit the e-mail group list

Explanation:

This helps to make sure that the e-mail ID bears some resemblance to the name in the Dummy Profile. It would look very strange if an e-mail ID was Jsmith and the name was Sue Lancaster. Additionally, the program should have the ability to “sign” the e-mails by inserting the name of the person (either first, or first and last) at the bottom of the text of the question.

Non-standard—special items may be encountered on forms. These are items such as a text box for entry of the time the problem occurred, or to choose from the drop down menu a specific option of some type—like what type of browser was used. These need to be handled in a special way because the Profiles may not provide an effective solution.

The program needs to know which fields from which tables are used on the form and how to “skip” fields if the user does not want to tie any date field to them, as they may be optional. Needs to be able to handle text boxes, option boxes, drop-down boxes, and check boxes. For example, the salutation field is frequently a drop-down box. In the dummy profile table it is also a drop-down box entry. The program should be able to match both so that the correct selection is made on the form.

Define Survey Parameters (Step 4)

Purpose:

Stores the setup information of how the user wants the survey conducted. This is a screen that allows the user to define how the survey should take place with menu boxes, option buttons for selecting user definable parameters.

User Actions Available:

Allow user to name the survey so it can be saved

Designate the Begin Date/Time and End Date/Time

Designate how frequently the survey is to be done once the Begin Date/Time has activated the survey

Allow user to select a database consisting of pre-populated e-mail addresses/web form addresses that this survey is to be sent to

Allow the User to select a database consisting of pre-populated questions that this survey will send.

Allow the User to select a database consisting of pre-populated dummy profiles that may be used by the survey to sign the e-mails with or to fill in form related information with.

Allow the User to add, delete or edit surveys.

Allow the User to enter a note about this survey.

Explanation:

Once the Begin Date/Time is met the survey continually runs until the End Date/Time. The survey will run according to the frequency schedule as selected by the user. Each time it runs it starts at the beginning of the question database and selects one question at a time. This question is either e-mailed to the e-mail address list or submitted to a web form. When a response is sent back, the program must be able to determine from the addresses alone when the question was originally submitted and where it links back to as far as the original question sent, dummy profile used, time originally sent, etc . . . . This will be used to allow the program to analyze the data. The e-mail addresses/form addresses, questions and dummy profiles are all created by the user and stored in databases so that the program can go through a designated list consisting of a number of them. Creation of these is explained below.

While a survey is running, the user has the ability to stop the survey and modify it or delete it altogether.

The user should have the ability to save Survey Parameters so they don't have to keep entering the same parameters over and over again for similar surveys. However, each user may be limited in the number of surveys they can have setup and running at one time and saved, as this uses up database space.

All times are based on the user's time zone specified in user setup information. This time zone is translated so that the server sends it at the right time as specified by the user's time zone. The server may be in a different time zone so it is important to match when the user wants it sent.

The user should have the ability to end or modify the survey at anytime. Once a survey reaches its end as designated by the user (the end date/time), the program should notify the user that it is complete. The survey should be listed in the status list as complete. Once the survey is complete, the user has the option to archive it or delete the results. The archive option will make the survey data available in the analysis section and free up a survey slot so a new survey can be created. The user needs to have a way to select and retrieve and view the data from old surveys if necessary or export the data for another tool to analyze. Archived data may need to be compressed if it gets too big or the user may have to be limited in how much data they can store (will have to determine observing usage of system).

Generating Selecting and Removing E-Mail Addresses (Step 5)

Purpose:

The program needs to be able to create e-mail ID's on multiple different ISP's accounts. These accounts will most probably be POP type accounts. Once created it needs to know how many are available and when/where they are being used. It must be able to use the appropriate address for the appropriate e-mail, then when done sending change the e-mail ID information.

Explanation:

The program should use a large database containing a list of first and last names to create a variety of different types of e-mail IDs that can be matched to different domain names of the different ISP accounts. This will allow for a very large number of unique e-mail IDs that are required for the program to individually identify each and every e-mail that is sent. The reason for this is that no other identification scheme can be assured to be included in the response e-mail that may be received except for the e-mail address of the receiver. Thus this needs to be unique for identification purposes.

All the accounts should be set to forward any e-mails received to a central account where the program will be able to store valid information for analysis.

Sending E-Mail (Step 6)

Purpose:

The program needs to know what domain names are available and what e-mail addresses can be used. It should know what URLs, ISP accounts and E-mail IDs are available for use and how many have been assigned and are going to be used with a time period. It should also know information about the administrator passwords used to create the IDs, their SMTP and POP3 information and all other information that is required for the outbound program to access, create and delete e-mail IDs automatically.

Submitting Data to Web Based Forms (Step 6)

Purpose:

Tells the program how to navigate the data elements stored on a forms based e-mail submission page.

The program needs to know the address of this page, what elements exist there, which elements should be submitted to, and what database items should be submitted. The program needs to be initially taught by the user how to accomplish this.

User Actions Available:

Allow the User to Record actions

Allow the User to Save Recorded actions

Allow the User to Modify saved actions

Allow the User to Test the Recorded actions

Allow the User to Delete Saved Recordings

Explanation:

After engaging a “Record” function, the user is allowed to “show” the program how it should navigate and fill in the form(s) of a website. This means that the program should enter from the point the user designates, such as the main home page URL, and continue following links from there. Once on the page with the form to fill in, the user will click on the fields to be filled in. The script recorder should then allow the user to designate which database field(s) of the system to tie that form field to. This could entail multiple entries on multiple pages, and needs to be able to handle all types of form elements (such as drop down boxes, option buttons, etc . . . ) that may be encountered.

The user should be allowed to modify a saved recording by removing or adding the HTML links that the recording follows, or adding or removing form fields to database fields designations.

The user must be allowed to save the recording. There is no need for the user to name the recording since it should automatically be associated with the form that it is supposed to run on.

Lastly, the user should have the ability to test the recording. This will run the recording, and the user should either see that the fields were selected the way they should be to validate the test was correct, or see the validation page of a form stating that data was successfully submitted (i.e. the recording submitted test data to the system and it was accepted successfully).

The program also needs to be able to verify if it can successfully complete the form submittal process. This is to check if there have been any changes to the form since the user recorded it that may require updates to the particular recording. If any modifications are made to a recording after the script was last verified, a warning needs to be generated so that the user is aware that the script has not been tested.

Receiving E-Mail (Step 7)

Purpose:

Tracks all e-mail responses or answers that may come back. The program then analyzes the header information of the e-mail, and extracts information from the header and body to store in a database.

Explanation:

The program should be able to receive e-mail from hundreds of other e-mail accounts that will be forwarding their received mail to this central account. The central account is where the program should be able to examine the header information of each e-mail and determine how to store in the database system. The program stores only relevant data that the program extracts from the header and body of each e-mail. Additionally, it only stores information from e-mails that make it past a junk mail filter that deletes mail that does not belong in the analysis. It should also be able to identify multiple replies to the same question.

Generating Analysis, Charts and Reports on the Collected Data (Step 8)

Purpose:

Allows the user to perform analysis and examine and interact with charts and reports on data collected by the survey. There should be a number of “standard” reports/charts that are generated. The user should also be allowed to manipulate the analysis to examine other aspects of the data that may help to draw conclusions.

User Actions Available:

Allow the User to select the type of report or chart to generate

Allow the User to designate the options of the analysis (such as time periods, data sets, etc . . . )

Allow the User to select the type of chart and modify it for aesthetic purposes

Allow the User to export data results to a file

Allow the User to save their preferences setup

Explanation:

The analysis should mainly involve queries against the collected survey information. It should be able to analyze any sets of collected survey data that the user may wish to analyze. This should include a variety of statistical and qualitative types of analysis. The charts can include graphical representations of this data. The reports should consist of pre-formatted templates that the data is dropped into once the user has specified their preferences.

Once the survey results are collected, the program should run analysis on the data either when the user asks for a report, or in advance based on amount of time it may take to run.

There are four main areas that need to be analyzed:

1) speed of the response

2) personalization of the response

3) format of the response

4) accuracy of the response

The speed of the response is the computed response time for each question and answer series. This is a measure of how long it took for an answer to come back after a question was sent to a specified address. This tells both the actual and perceived times—actual is based off of the time difference that the receiver sees, and perceived is based off of the time difference that the sender sees. The e-mail header contains this information and should be parsed.

The personalization and format of the response should be analyzed by having the program examine the body of the text of the e-mail response.

This aspect should be designed so the user does not have to wait too long, or be aware of how long it will take for the analysis to run.

The user should also have the ability to export the results data in standard accepted formats (such as comma delimited) so that further analysis can be performed.

FIG. 2 depicts schematically the flow of user input, automatic actions, and key functional aspects of this preferred embodiment of the invention.

What is claimed is:

1. A web-based survey method for measuring customer service response, comprising:
creating and storing a plurality of questions to be sent to customer service web sites;
grouping the questions into one or more groups;
storing service web site destination identifying information;
defining the parameters of a service survey, including at least the questions for the survey and the service web site destination identifying information;
responsive to at least one parameter of the defined survey, automatically transmitting one or more questions from the survey to one or more service web site destinations from the survey;
storing emailed responses received from the destination service web sites; and
automatically extracting and storing data from the stored emailed responses.

2. The web-based survey method of claim 1, wherein there are a plurality of groups of questions.

3. The web-based survey method of claim 1, wherein the service web site destination identifying information comprises email addresses.

4. The web-based survey method of claim 1, wherein the service web site destination identifying information comprises the address of a web-based form.

5. The web-based survey method of claim 1, wherein defining service survey parameters further includes defining the survey start time.

6. The web-based survey method of claim 5, wherein defining service survey parameters further includes defining the survey end time.

7. The web-based survey method of claim 6, wherein defining service survey parameters further includes the survey frequency between the start time and end time.

8. The web-based survey method of claim 1, wherein defining service survey parameters further includes selecting a question group.

9. The web-based survey method of claim 1, further comprising creating and storing one or more dummy user profiles.

10. The web-based survey method of claim 9, wherein defining service survey parameters further includes selecting at least one dummy user profile for the survey.

11. The web-based survey method of claim 1, further comprising storing user actions involved in completing a web-based form.

12. The web-based survey method of claim 11, wherein automatically transmitting comprises using the stored user actions to place appropriate information in different fields of a web-based form.

13. The web-based survey method of claim 1, wherein automatically extracting includes resolving information from both the header and body of the emailed responses received.

14. A web-based survey method for measuring customer service response, comprising:
creating and storing a plurality of questions to be sent to customer service web sites;
grouping the questions into a plurality of groups;
creating and storing one or more dummy user profiles;
storing service web site destination identifying information including email addresses;
defining the parameters of a service survey, including at least selecting a question group for the survey, selecting the service web site destination email addresses, and selecting at least one dummy user profile for the survey;
responsive to at least one parameter of the defined survey, automatically transmitting one or more questions from the survey to one or more service web site destination from the survey;
storing emailed responses received from the destinations service web sites; and
automatically extracting and storing data from the stored emailed responses.

15. A web-based survey method for measuring customer service response, comprising:
creating and storing a plurality of questions to be sent to customer service web sites;
grouping the questions into a plurality of groups of questions;
storing service web site destination identifying information, wherein the service web site destination identifying information comprises at least the address of a web-based form;
storing user actions involved in completing a web-based form;
defining the parameters of a service survey, including at least the questions for the survey and the service web site destination identifying information;
responsive to at least one parameter of the defined survey, automatically using the stored user actions to place appropriate information in different fields of a web-based form, including transmitting one or more questions from the survey;
storing emailed responses received from the destinations service web sites; and
automatically extracting and storing data from the stored emailed responses.
